(19) United States
(12) Patent Application Publication
(10) Pub. No.: US 2023/0169070 A1
(43) Pub. Date: Jun. 1, 2023

(54) Data Transformations for Mapping Enterprise Applications

(71) Applicant: International Business Machines Corporation, Armonk, NY (US)

(72) Inventors: Ramkumar Ramalingam, Theni (IN); Nagarjuna Surabathina, Prakasam(dt) (IN); Thanmayi Mruthyunjaya, Dollers Colony (IN); Nitin Gupta, Saharanpur (IN); Pranay Kumar Lohia, Bhagalpur (IN); Shanmukha Chaitanya Guttula, Vijayawada (IN); Hima Patel, Bengaluru (IN); Sameep Mehta, Bengaluru (IN); Matu Agarwal, Bengaluru (IN); Mudit Mehrotra, Bengaluru (IN)

(21) Appl. No.: 17/456,854

(22) Filed: Nov. 29, 2021

(51) Int. Cl. G06F 16/242; G06F 16/25

(52) U.S. Cl. CPC G06F 16/242; G06F 16/258

(57) ABSTRACT

A computer implemented method, computer system, and computer program product for transforming mapped data fields of enterprise applications. A number of processor units receiving a matching from a source data field to a target data field. The set of processor units receiving a number of annotated examples of transformations from a source format to a target format. Based on the annotated examples, the set of processor units autogenerating a query language expression for transforming data items from the source format to the target format.

### BACKGROUND

### 1. Field

The present invention relates to data processing in general, and in particular, to autogeneration of query language expressions for transforming mapped data fields of enterprise applications.

### 2. Description of the Related Art

Data integration is a group of technical and business processes, such as extract/transform/load (ETL), data replication and data virtualization, that combine data from disparate sources into a meaningful and valuable data set for business intelligence and business analytics. Data integration is critical to helping companies consolidate data into a single, trusted view for analysis and ultimately, to drive business. Solid data integration processes must be followed to make sure that the data is managed and governed, and ultimately trusted.

### SUMMARY

According to one illustrative embodiment, a computer-implemented method autogenerates query language expressions for transforming mapped data fields of enterprise applications. A number of processor units receive a matching from a source data field to a target data field. The set of processor units receive a number of annotated examples of transformations from a source format to a target format. Based on the annotated examples, the set of processor units autogenerate a query language expression for transforming data items from the source format to the target format.

According to other illustrative embodiments, a computer system and computer program product for autogenerates query language expressions for transforming mapped data fields of enterprise applications are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a data integration environment in accordance with one or more illustrative embodiments;

FIG. 4 is an example of a graphical user interface for matching data fields in accordance with one or more illustrative embodiments;

FIG. 5 is an example of a graphical user interface for autogenerating a query language expression from an enumerated value of a source data field in accordance with one or more illustrative embodiments;

FIG. 6 is an example of a graphical user interface for autogenerating a query language expression from a string value of a source data field in accordance with one or more illustrative embodiments;

FIG. 7 is a flowchart illustrating a process for autogenerating query language expressions for transforming mapped data fields of enterprise applications in accordance with one or more illustrative embodiments;

FIG. 8 is a flowchart illustrating a process for autogenerating a query language expression from an enumerated value of a source data field in accordance with one or more illustrative embodiments;

FIG. 9 is a flowchart illustrating a process for autogenerating a query language expression from a string value of a source data field in accordance with one or more illustrative embodiments; and

FIG. 10 is a flowchart illustrating a process for selecting the query language expression from potential expressions in accordance with one or more illustrative embodiments.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

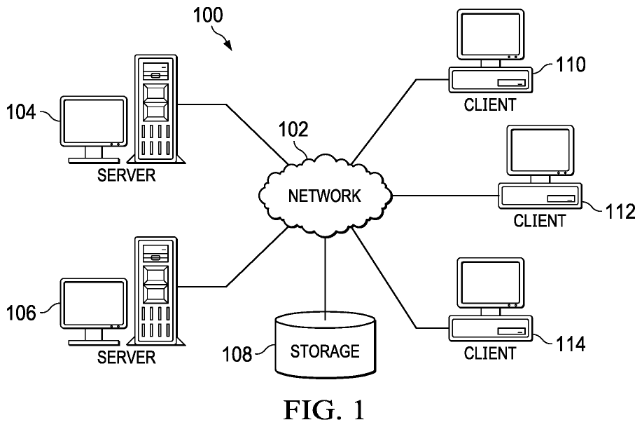

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 may be, for example, a heterogeneous distributed computing environment such as a multi-cloud environment comprised of a plurality of clouds corresponding to different cloud providers and a plurality of edge devices.

Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, server 104 and server 106 may each represent multiple computing nodes in one or more cloud environments. Alternatively, server 104 and server 106 may each represent a cluster of servers in one or more data centers.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102. Users, such as, for example, information technology operations administrators, multi-cloud infrastructure administrators, multi-cloud security analysts, and the like, corresponding to clients 110, 112, and 114 may utilize clients 110, 112, and 114 to access and utilize the multi-cloud asset error management services provided by server 104 and server 106.

Storage 108 is a network storage device capable of storing any type of data in a structured format or an unstructured format. In addition, storage 108 may represent a plurality of network storage devices. Further, storage 108 may store cloud identifiers, identifiers, and network addresses for a plurality of servers, edge devices, and client devices. Furthermore, storage 108 may store other types of data, such as, for example, authentication or credential data that may include usernames, passwords, and the like associated with multi-cloud administrators and users.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network, a local area network, a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

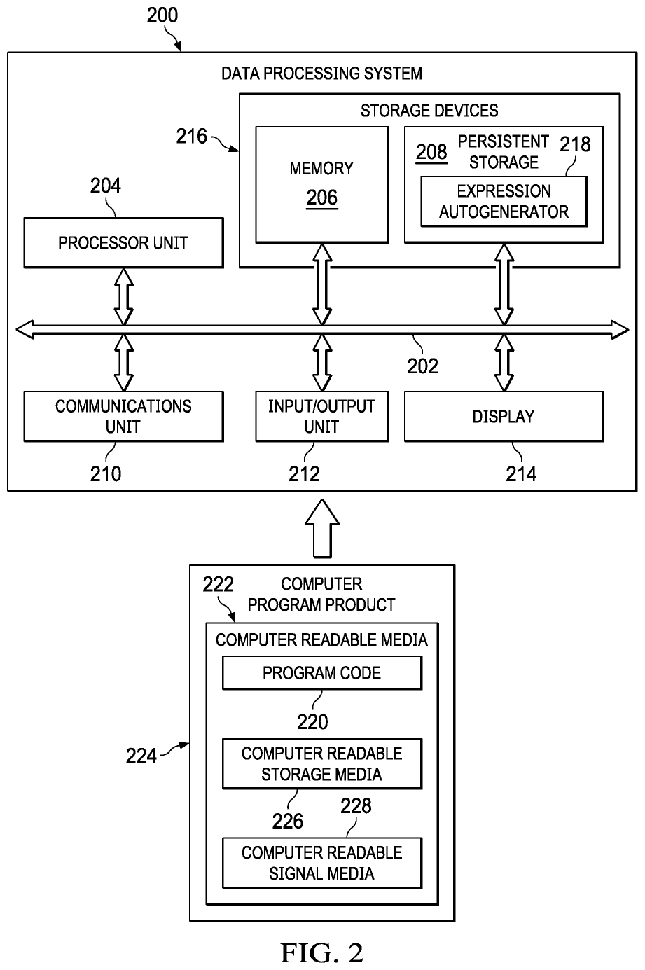

With reference now to FIG. 2, a diagram of a data processing system is depicted in accordance with one or more illustrative embodiments. Data processing system 200 is an example of a computer, such as server 104 in FIG. 1, in which computer-readable program code or instructions implementing the asset error management processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores expression autogenerator 218. However, it should be noted that even though expression autogenerator 218 is illustrated as residing in persistent storage 208, in an alternative illustrative embodiment, expression autogenerator 218 may be a separate component of data processing system 200. For example, expression autogenerator 218 may be a hardware component coupled to communication fabric 202 or a combination of hardware and software components. In another alternative illustrative embodiment, a first set of components of expression autogenerator 218 may be located in data processing system 200 and a second set of components of expression autogenerator 218 may be located in a second data processing system, such as, for example, server 106 in FIG. 1.

The illustrative examples recognize and take into account that inconsistent data between source and target is a key problem faced by data integrators. Flow mappings for data integration require two steps: (1) finding the right mapping for source and target connector attributes; and (2) generating and applying the query language expressions to transform source attributes format to target attributes format. A user has to generate these transformations manually, which requires a thorough understanding of both data characteristics and the query language to generate correct expressions, in a time consuming and labor-intensive process requiring highly skilled integrators.

Expression autogenerator 218 controls the process of autogenerating query language expressions for transforming mapped data fields of enterprise applications 219. Expression autogenerator 218 receives a matching from a source data field to a target data field. Expression autogenerator 218 receives a number of annotated examples of transformations from a source format to a target format. In one illustrative example, expression autogenerator 218 receives an enumerated value for the source data field and the target data field and identifies transformation rules for the enumerated values according to a rule-based system. In one illustrative example, expression autogenerator 218 provides the number of annotated examples to an artificial intelligence system and determines patterns of substring among the annotated examples using the artificial intelligence system.

Based on the annotated examples, expression autogenerator 218 autogenerates a query language expression for transforming data items from the source format to the target format. In one illustrative example, expression autogenerator 218 autogenerates the query language expression for an enumerated value according to the transformation rules that were identified. In one illustrative example, expression autogenerator 218 autogenerates the query language expression for a string value based on the patterns of substring determined by the artificial intelligence system.

Expression autogenerator 218 may generate expressions written in JSONata, a lightweight query and transformation language for JSON data. These autogenerated JSONata expressions map data fields between the source and target, corresponding to different data connectors for mapping enterprise applications 219.

Expression autogenerator 218 assists users in the mapping of enterprise applications 219 by generating simpler JSONata expressions for the fields mapped between source and target fields corresponding to different data connectors. Using a few input and output samples corresponding to source and target fields respectively, expression autogenerator 218 generates pattern based JSONata expressions that give more priority to simpler expressions and operators for ease of operator understanding.

Expression autogenerator 218 analyzes the user-provided annotations to detect multiple patterns and then learns a program for each pattern. When expression autogenerator 218 determines that the annotations are insufficient for that pattern, expression autogenerator 218 can notify a user to provide more annotations of same type.

Expression autogenerator 218 allows the user to evaluate the generated programs, and, in case of failure, to add new samples to input and output and to regenerate more generalized query language expressions. The user can edit the input and output annotations to refine the expressions, which can be stored and reused for similar data flows.

As a result, data processing system 200 operates as a special purpose computer system in which expression autogenerator 218 in data processing system 200 enables autogenerating query language expressions for transforming mapped data fields of enterprise applications 219. In particular, expression autogenerator 218 transforms data processing system 200 into a special purpose computer system as compared to currently available general computer systems that do not have expression autogenerator 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 220 is located in a functional form on computer-readable media 222 that is selectively removable and may be loaded onto or transferred to data processing system 200 for running by processor unit 204. Program code 220 and computer-readable media 222 form computer program product 224. In one example, computer-readable media 222 may be computer-readable storage media 226 or computer-readable signal media 228.

In these illustrative examples, computer-readable storage media 226 is a physical or tangible storage device used to store program code 220 rather than a medium that propagates or transmits program code 220. Computer-readable storage media 226 may include, for example, an optical or magnetic disc that is inserted or placed into a drive or other device that is part of persistent storage 208 for transfer onto a storage device, such as a hard drive, that is part of persistent storage 208. Computer-readable storage media 226 also may take the form of a persistent storage, such as a hard drive, a thumb drive, or a flash memory that is connected to data processing system 200.

Alternatively, program code 220 may be transferred to data processing system 200 using computer-readable signal media 228. Computer-readable signal media 228 may be, for example, a propagated data signal containing program code 220. For example, computer-readable signal media 228 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media” can be singular or plural. For example, program code 220 can be located in computer-readable media 222 in the form of a single storage device or system. In another example, program code 220 can be located in computer-readable media 222 that is distributed in multiple data processing systems. In other words, some instructions in program code 220 can be located in one data processing system while other instructions in program code 220 can be located in one or more other data processing systems. For example, a portion of program code 220 can be located in computer-readable media 222 in a server computer while another portion of program code 220 can be located in computer-readable media 222 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 220.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Thus, the illustrative embodiments provide a computer implemented method, apparatus, system, and computer program for autogenerating query language expressions for transforming mapped data fields of enterprise applications 219. A number of processor units receiving a matching from a source data field to a target data field. The set of processor units receiving a number of annotated examples of transformations from a source format to a target format. Based on the annotated examples, the set of processor units autogenerating a query language expression for transforming data items from the source format to the target format.

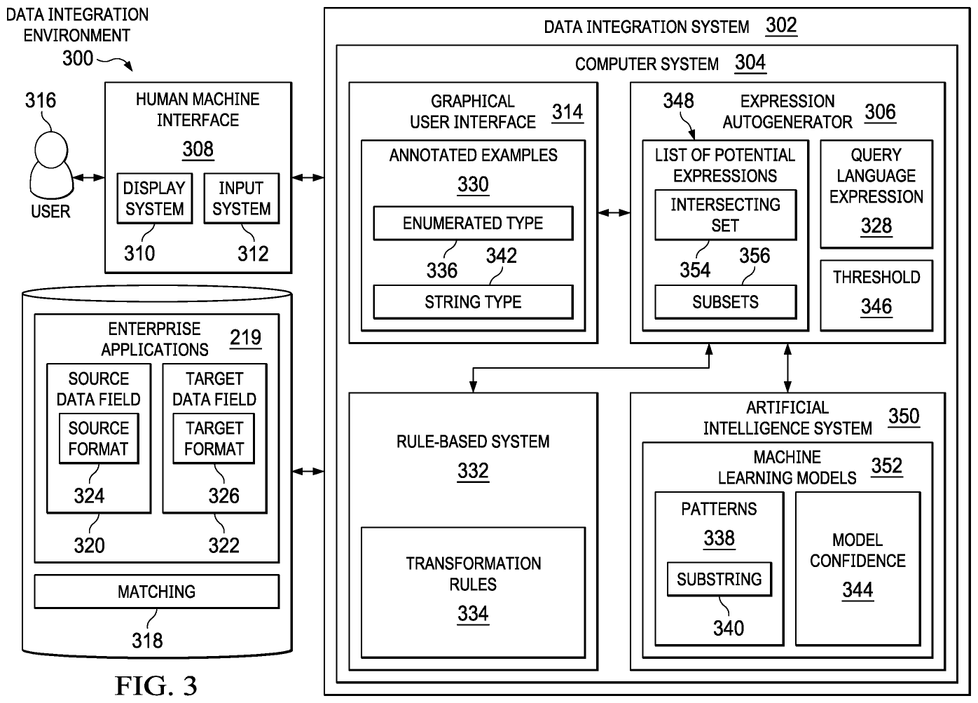

Referring now to FIG. 3, a block diagram of a data integration environment is depicted in accordance with one or more illustrative embodiments. In this illustrative example, data integration environment 300 includes components that can be implemented in hardware such as the hardware shown in network data processing system 100 in FIG. 1 and data processing system 200 in FIG. 2.

As depicted, data integration system 302 comprises computer system 304 and expression autogenerator 306. Expression autogenerator 306 runs in computer system 304. Expression autogenerator 306 provides methods for autogenerating query language expressions for transforming mapped data fields of enterprise applications 219.

Expression autogenerator 306 can be implemented in software, hardware, firmware, or a combination thereof. When software is used, the operations performed by expression autogenerator 306 can be implemented in program instructions configured to run on hardware, such as a processor unit. When firmware is used, the operations performed by can be implemented in program instructions and data and stored in persistent memory to run on a processor unit. When hardware is employed, the hardware may include circuits that operate to perform the operations in expression autogenerator 306.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 304 is a physical hardware system and includes one or more data processing systems. When more than one data processing system is present in computer system 304, those data processing systems are in communication with each other using a communications medium. The communications medium can be a network. The data processing systems can be selected from at least one of a computer, a server computer, a tablet computer, or some other suitable data processing system.

Data mapping bridges the differences between two systems, or data models, so that when data is moved from a source, it is accurate and usable at the destination. If not properly mapped, data may become corrupted as it moves to its destination. Generally, data mapping includes data matching and data transformation.

Data matching—also known as record linkage, and entity resolution, as well as many other terms—is the task of finding records in a data set that refer to the same entity across different data sources, for example, data files, books, websites, and databases. Data matching is necessary when joining different data sets based on entities that may or may not share a common identifier, such as a database key, URI, or National identification number, which may be due to differences in record shape, storage location, or curator style or preference.

Inconsistent data between the source and target is a key problem faced by integrators. Data transformation is the process of converting data from a source format to a target format. This can include cleansing data by changing data types, deleting nulls or duplicates, aggregating data, enriching the data, or other transformations. To properly integrate data, highly skilled integrators must understand data characteristics, and write scripted expressions to affect the transformation.

In this illustrative example, expression autogenerator 306 receiving a matching 318 from a source data field 320 to a target data field 322. Source data field 320 and target data field 322 store data items in different formats, respectively, source format 324 and target format 326. Based on annotated examples received from user 316, expression autogenerator 306 autogenerates query language expression 328 for transforming data items from the source format 324 to the target format 326.

As depicted, human machine interface 308 comprises display system 310 and input system 312. Display system 310 is a physical hardware system and includes one or more display devices on which graphical user interface 314 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 316 is a person that can interact with graphical user interface 314 through user input generated by input system 312 for computer system 304. Input system 312 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 308 can enable user 316 to interact with one or more computers or other types of computing devices in computer system 304. For example, these computing devices can be client devices such as clients 110, 112, and 114 in FIG. 1. In the illustrative examples, human machine interface 308 enables user 316 to submit a number of annotated examples 330 to expression autogenerator 306.

As depicted, expression autogenerator 306 can use one or more different systems to autogenerate query language expression 328. For example, expression autogenerator 306 may use rule-based system 332 when source format 324 and target format 326 are evaluate enumerated value datatypes. Rule-based system 332 includes a set of transformation rules 334. Expression autogenerator 306 applies one or more transformation rules 334 to transform enumerated values from source format 324 to target format 326.

When expression autogenerator 306 receives an enumerated type 336 for the source data field and the target data field, expression autogenerator 306 identifies transformation rules for the enumerated type 336 data items according to a rule-based system 332. Expression autogenerator 306 autogenerates the query language expression 328 according to the transformation rules 334 that were identified.

In these illustrative examples, expression autogenerator 306 can use artificial intelligence system 350. Artificial intelligence system 350 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 350 can include a set of machine learning models 352. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output.

In one illustrative example, expression autogenerator 306 auto generates the query language expression 328 based on patterns 338 for substrings 340 of string type 342 data items identified by artificial intelligence system 350. For example, expression autogenerator 306 provides the number of annotated examples to an artificial intelligence system. Using the artificial intelligence system, expression autogenerator 306 determines patterns 338 of substrings 340 of string type 342 among the annotated examples 330. Using the artificial intelligence system, expression autogenerator 306 autogenerates the query language expression based on the patterns of substrings.

In one illustrative example, artificial intelligence system 350 determines a model confidence 344 of matches between patterns 338 of substrings 340. The model confidence 343 can correspond, for example, to a lower bound of an uncertainty interval. Expression autogenerator 306 can use this model confidence 344 value as a threshold for determining whether additional annotated examples are required. Expression autogenerator 306 may request a user 316 to provide additional annotated examples if the model confidence is below threshold 346 that is set by user 316.

In one illustrative example, expression autogenerator 306 generates a list of potential expressions 348 for each of the annotated examples 330. Expression autogenerator 306 then identifies an intersecting set 354 across the list of potential expressions 348 for each of the annotated examples 330. Expression autogenerator 306 selects the query language expression 328 from the intersecting set 354.

In one illustrative example, expression autogenerator 306 selecting the query language expression giving preference to shorter algorithms that use simpler transformations. For example, expression autogenerator 306 may give preference to an algorithm that uses split and replace operations over an algorithm that uses more complex operations. In this illustrative example, expression autogenerator 306 ranks the intersecting set 354 according to expression length and operator complexity and selects the query language expression 328 according to the ranking of intersecting set 354.

In one illustrative example, expression autogenerator 306 can identify inconsistent data patterns one or more of source format 324 and target format 326. For example, if there are no common expressions are identified across the list of potential expressions 348 for each of the annotated examples 330, that is, if the intersecting set 354 is a null set, expression autogenerator 306 may assume that multiple patterns exist within the data set and split the list of potential expressions 348 into multiple subsets 356. Expression autogenerator 306 may then request a user 316 to provide additional annotated examples for each subset 356.

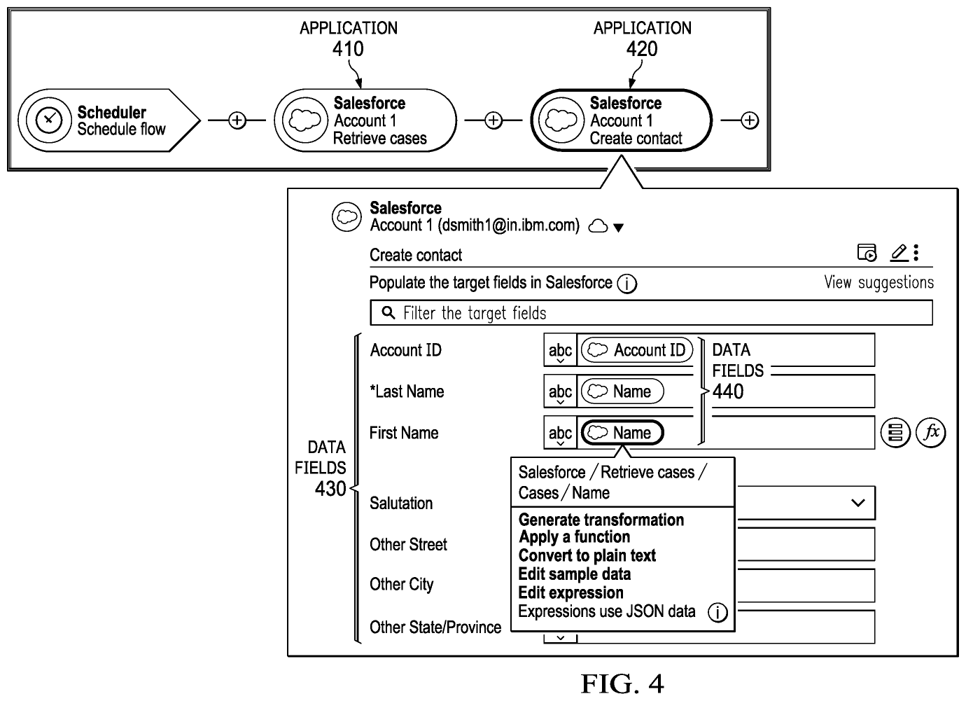

With reference next to FIG. 4, a graphical user interface for mapping data fields between enterprise applications is depicted according to one or more illustrative embodiments. Graphical user interface 400 is an example of graphical user interface 314 of FIG. 3.

As depicted, graphical user interface 400 and maps source data fields 430 of application 410 to target data fields 440 of application 420. Mapping suggestions between source data fields 430 and target data fields 440 can be entered manually by a user, or be generated automatically by an artificial intelligence (AI) model and provided as a service, such as Map Assist, available from International Business Machines Corp.

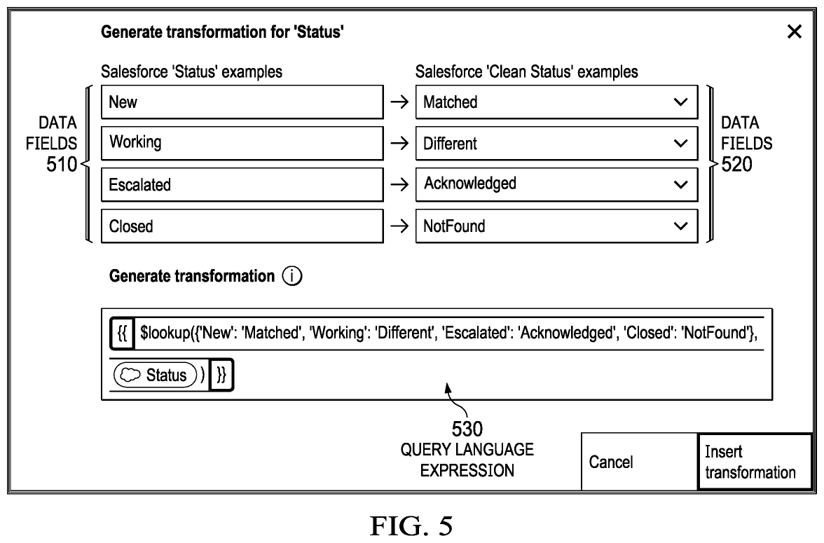

With reference next to FIG. 5, a graphical user interface for mapping enumerated data types between enterprise applications is depicted according to one or more illustrative embodiments. Graphical user interface 500 is an example of graphical user interface 314 of FIG. 3.

As depicted, graphical user interface 500 and maps data fields 510 to data fields 520. Graphical user interface 500 selection of an enumerated value for each of data fields 520 matches a corresponding one of data fields 510. From these annotated examples, query language expression 530 can be generated to transform data fields 510 from a source format of data fields 510 to a target format of data fields 520.

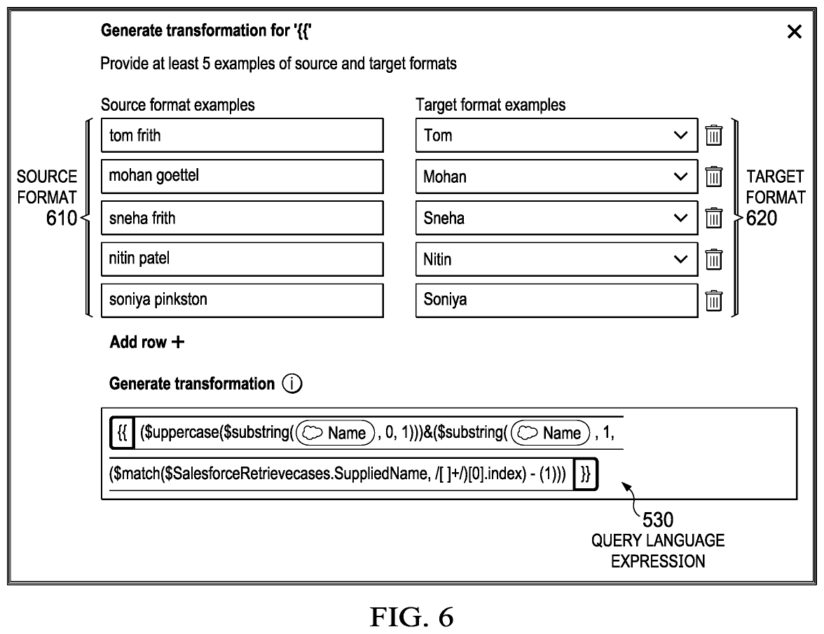

With reference next to FIG. 6, a graphical user interface for mapping string data types between enterprise applications is depicted according to one or more illustrative embodiments. Graphical user interface 600 is an example of graphical user interface 314 of FIG. 3.

As depicted, graphical user interface 600 displays a number of annotated examples of a mapped data field in both source format 610 and target format 620. From these annotated examples, query language expression 630 is generated to transform a corresponding data field from a source format 610 to a target format 620.

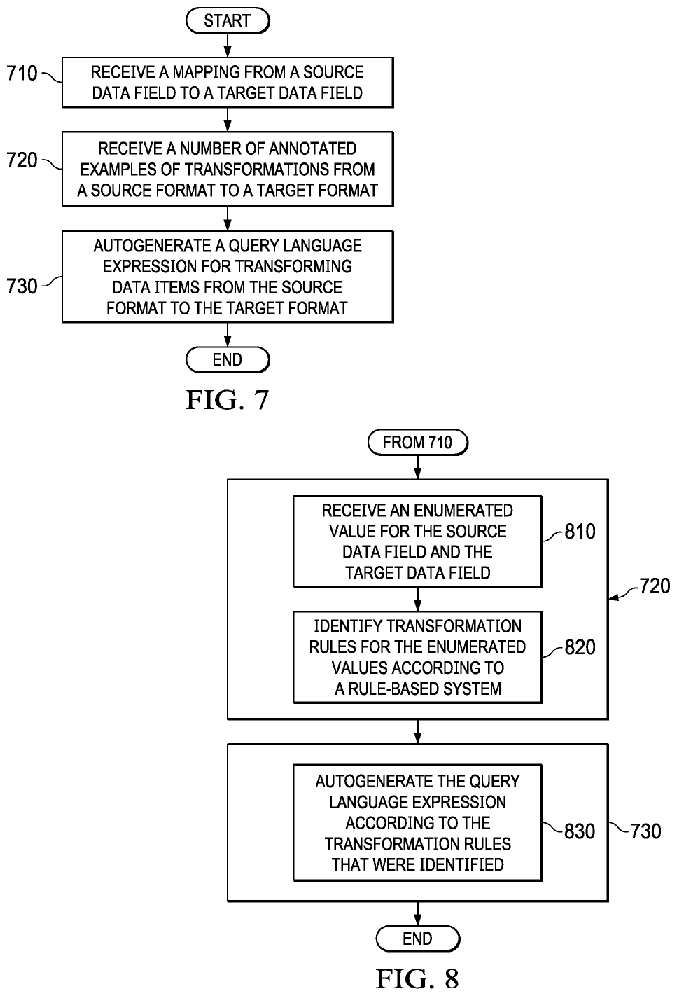

With reference now to FIG. 7, a diagram illustrating an example of a process for autogenerating query language expressions for transforming mapped data fields of enterprise applications is depicted in accordance with one or more illustrative embodiments. Process 700 may be implemented in an expression autogenerator of a data integration environment, such as, for example, expression autogenerator 306 in FIG. 3.

The process begins by receiving a matching from a source data field to a target data field (step 710). The process receives a number of annotated examples of transformations from a source format to a target format (step 720). Based on the annotated examples, the process autogenerating a query language expression for transforming data items from the source format to the target format (step 730). Thereafter, the process terminates.

With reference now to FIG. 8, a diagram illustrating an example of a process for autogenerating a query language expression from an enumerated value of a source data field is depicted in accordance with one or more illustrative embodiments. The process illustrated in FIG. 8 is one illustrative example of process steps 720 and 730 shown in FIG. 7.

Continuing from step 710, the process receives a number of annotated examples, as shown in step 720 of FIG. 7. In this illustrative example, the process receives a number of annotated examples by receiving an enumerated value for the source data field and the target data field (step 810) and identifying transformation rules for the enumerated values according to a rule-based system (step 820).

The process autogenerates the query language expression, as shown in step 730 of FIG. 7. In this illustrative example, the process autogenerates the query language expression by autogenerating the query language expression according to the transformation rules that were identified (step 830). Thereafter, the process terminates.

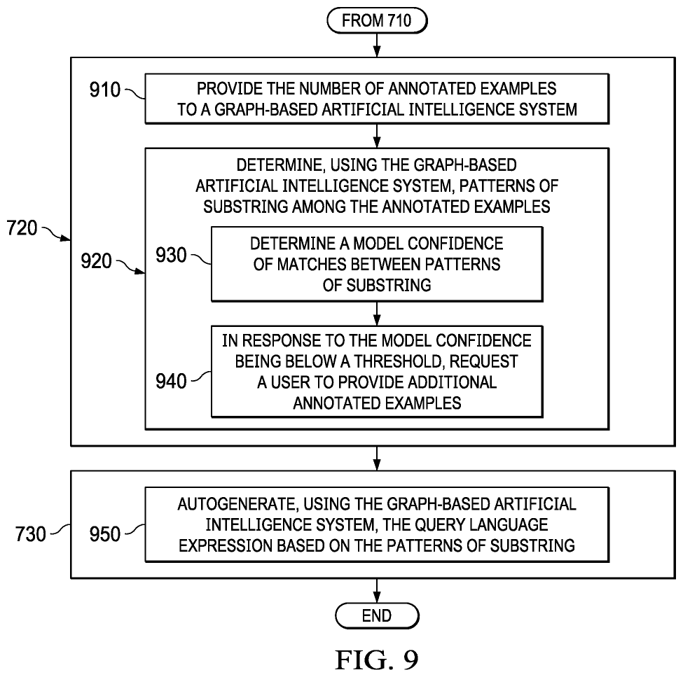

With reference now to FIG. 9, a diagram illustrating an example of a process for autogenerating a query language expression from a string value of a source data field in accordance with one or more illustrative embodiments. The process illustrated in FIG. 9 is one illustrative example of process steps 720 and 730 as shown in FIG. 7.

Continuing from step 710, the process provides the number of annotated examples to an artificial intelligence system (step 910). Using the artificial intelligence system, the process determines patterns of substring among the annotated examples (step 920).

In one illustrative example, determining the patterns of substring can include determining a model confidence of matches between patterns of substring (step 930). In response to the model confidence being below a threshold, the process requests a user to provide additional annotated examples (step 940).

Continuing from step 720, the process autogenerating a query language expression, as shown in step 730 of FIG. 7. In this illustrative example, the process auto generates the query language expression by using the artificial intelligence system to auto generate the query language expression based on the patterns of substring (step 950). Thereafter, the process terminates.

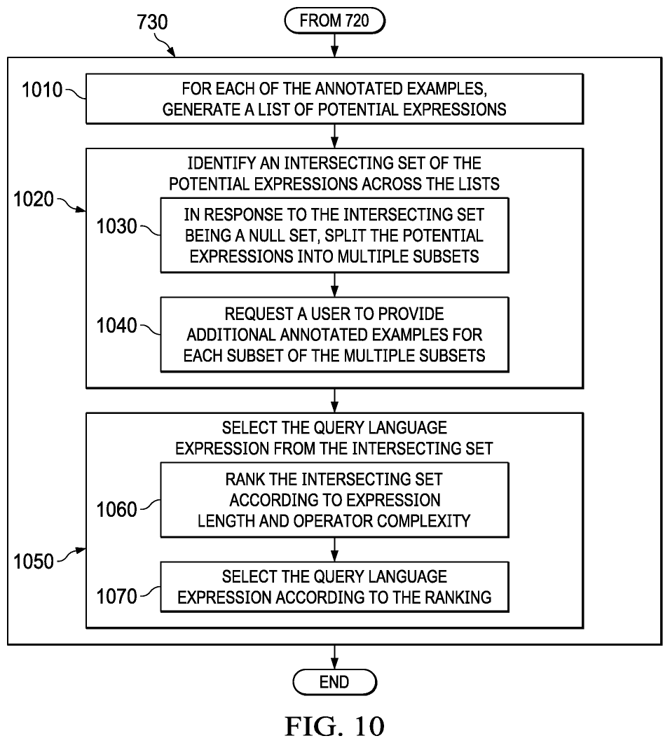

With reference now to FIG. 10, a diagram illustrating an example of a process for selecting the query language expression from potential expressions is depicted in accordance with one or more illustrative embodiments. The process illustrated in FIG. 9 is one illustrative example of process step 730 as shown in FIG. 7.

Continuing from step 720, for each of the annotated examples, the process generates a list of potential expressions (step 1010). The process identifies an intersecting set of the potential expressions across the lists (step 1020).

In one illustrative example, identifying an intersecting set can include splitting the potential expressions into multiple subsets in response to the intersecting set being a null set (step 1030). The process may then request a user to provide additional annotated examples for each subset of the multiple subsets (step 1040).

The process selects the query language expression from the intersecting set (step 1050). In one illustrative example, selecting the query language expression includes ranking the intersecting set according to expression length and operator complexity (step 1060) and selecting the query language expression according to the ranking (step 1070). Thereafter, the process terminates.

Thus, the illustrative embodiments provide a computer implemented method, apparatus, system, and computer program products for transforming mapped data fields of enterprise applications. A number of processor units receiving a matching from a source data field to a target data field. The set of processor units receiving a number of annotated examples of transformations from a source format to a target format. Based on the annotated examples, the set of processor units autogenerating a query language expression for transforming data items from the source format to the target format.

The description of the different illustrative embodiments has been presented for purposes of illustration and description and is not intended to be exhaustive or limited to the embodiments in the form disclosed. The different illustrative examples describe components that perform actions or operations. In one or more illustrative embodiments, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer-implemented method for autogenerating query language expressions for transforming mapped data fields of enterprise applications, the method comprising:
receiving, by a number of processor units, a data matching from a source data field to a target data field;
receiving, by the number of processor units, a number of annotated examples of transformations from a source format to a target format; and
based on the annotated examples, autogenerating, by the number of processor units, a query language expression for transforming the source data field from the source format to the target data field in the target format.

2. The computer-implemented method of claim 1, wherein receiving the number of annotated examples further comprises:
receiving, by the number of processor units, an enumerated value for the source data field and the target data field; and
identifying, by the number of processor units, transformation rules for the enumerated values according to a rule-based system.

3. The computer-implemented method of claim 2, wherein autogenerating the query language expression further comprises:
autogenerating the query language expression according to the transformation rules that were identified.

4. The computer-implemented method of claim 1, wherein receiving the number of annotated examples further comprises:
providing, by the number of processor units, the number of annotated examples to an artificial intelligence system;
determining, by the number of processor units using the artificial intelligence system, patterns of substring among the annotated examples; and
autogenerating, by the number of processor units using the artificial intelligence system, the query language expression based on the patterns of substring.

5. The computer-implemented method of claim 4, wherein determining the patterns of substring further comprises:
determining, by the number of processor units, a model confidence of matches between patterns of substring; and
in response to the model confidence being below a threshold, requesting, by the number of processor units, a user to provide additional annotated examples.

6. The computer-implemented method of claim 1, wherein autogenerating the query language expression further comprises:
for each of the annotated examples, generating a list of potential expressions;
identifying, by the number of processor units, an intersecting set of the potential expressions across the lists; and
selecting the query language expression from the intersecting set.

7. The computer-implemented method of claim 6, wherein identifying the intersecting set further comprising:
in response to the intersecting set being a null set, splitting, by the number of processor units, the potential expressions into multiple subsets; and
requesting, by the number of processor units, a user to provide additional annotated examples for each subset of the multiple subsets.

8. The computer-implemented method of claim 6, wherein selecting the query language expression further comprises:
ranking, by the number of processor units, the intersecting set according to expression length and operator complexity; and
selecting, by the number of processor units, the query language expression according to the ranking.

9. A computer system comprising:
a number of processor units, wherein the number of processor units executes instructions to:
receive a data matching from a source data field to a target data field;
receive a number of annotated examples of transformations from a source format to a target format; and
based on the annotated examples, autogenerate a query language expression for transforming the source data field from the source format to the target data field in the target format.

10. The computer system of claim 9, wherein in receiving the number of annotated examples, the number of processor units further execute the instructions to:
receive an enumerated value for the source data field and the target data field; and
identify transformation rules for the enumerated values according to a rule-based system.

11. The computer system of claim 10, wherein in autogenerating the query language expression, the number of processor units further execute the instructions to:
autogenerate the query language expression according to the transformation rules that were identified.

12. The computer system of claim 9, wherein in receiving the number of annotated examples, the number of processor units further execute the instructions to:
provide the number of annotated examples to an artificial intelligence system;
determine, using the artificial intelligence system, patterns of substring among the annotated examples; and
autogenerate, using the artificial intelligence system, the query language expression based on the patterns of substring.

13. The computer system of claim 12, wherein in determining the patterns of substring, the number of processor units further execute the instructions to:
determine a model confidence of matches between patterns of substring; and
in response to the model confidence being below a threshold, request a user to provide additional annotated examples.

14. The computer system of claim 9, wherein in autogenerating the query language expression, the number of processor units further execute the instructions to:
for each of the annotated examples, generate a list of potential expressions;
identify an intersecting set of the potential expressions across the lists; and
select the query language expression from the intersecting set.

15. The computer system of claim 14, wherein in identifying the intersecting set, the number of processor units further execute the instructions to:
in response to the intersecting set being a null set, split the potential expressions into multiple subsets; and
request a user to provide additional annotated examples for each subset of the multiple sub sets.

16. The computer system of claim 15, wherein in selecting the query language expression, the number of processor units further execute the instructions to:
rank the intersecting set according to expression length and operator complexity; and
select the query language expression according to the ranking.

17. A computer program product for autogenerating query language expressions for transforming mapped data fields of enterprise applications, the computer program product comprising a computer readable storage medium having program instructions embodied therewith, the program instructions executable by a computer system to cause the computer system to perform a method of:
receiving, by a number of processor units, a data matching from a source data field to a target data field;
receiving, by the number of processor units a number of annotated examples of transformations from a source format to a target format; and
based on the annotated examples, autogenerating, by the number of processor units, a query language expression for transforming the source data field from the source format to the target data field in the target format.

18. The computer program product of claim 17, wherein receiving, by the number of processor units, the number of annotated examples further comprises:
receiving, by the number of processor units, an enumerated value for the source data field and the target data field; and
identifying transformation rules for the enumerated values according to a rule-based system.

19. The computer program product of claim 18, wherein autogenerating, by the number of processor units, the query language expression further comprises:
autogenerating, by the number of processor units, the query language expression according to the transformation rules that were identified.

20. The computer program product of claim 17, wherein receiving, by the number of processor units, the number of annotated examples further comprises:
providing, by the number of processor units, the number of annotated examples to an artificial intelligence system;
determining, by the number of processor units using the artificial intelligence system, patterns of substring among the annotated examples; and
autogenerating, by the number of processor units using the artificial intelligence system, the query language expression based on the patterns of substring.
